(19) United States
(12) Patent Application Publication
(10) Pub. No.: US 2019/0347087 A1
(43) Pub. Date: Nov. 14, 2019

(54) METHOD FOR REFLASHING ENGINE CONTROL UNITS FOR VEHICLE

(71) Applicant: Magna Electronics Inc., Auburn Hills, MI (US)

(72) Inventor: Albert C. Farah, Lasalle (CA)

(21) Appl. No.: 16/408,496

(22) Filed: May 10, 2019

Related U.S. Application Data
(60) Provisional application No. 62/669,441, filed on May 10, 2018.

(51) Int. Cl. G06F 8/65; B60R 16/023; H04L 12/40

(52) U.S. Cl. CPC G06F 8/65; B60R 16/023; H04L 2012/40273; H04L 2012/40215; H04L 12/40

(57) ABSTRACT

A method for reflashing a plurality of engine control units includes connecting a multi-channel power distributor to a power supply and connecting a plurality of engine control units (ECUs) to the multi-channel power distributor, with a respective ECU connected to a respective channel of the multi-channel power distributor. Each ECU is connected to a controller area network (CAN) controller, with each ECU connected to a different CAN channel. The CAN controller is connected to data processing hardware, and each ECU is reflashed simultaneously with the data processing hardware.

### CROSS REFERENCE TO RELATED APPLICATION

The present application claims the filing benefits of U.S. provisional application Ser. No. 62/669,441, filed May 10, 2018, which is hereby incorporated herein by reference in its entirety.

### FIELD OF THE INVENTION

The present invention relates generally to programming a controller and, more particularly, to programming an engine control unit of a vehicle.

### BACKGROUND OF THE INVENTION

Engine control units (ECUs) typically store software instructions in flash or other similar storage memory. Due to typical flash configuration, programming and/or updating flash is time consuming. Therefore, programming or updating large quantities of engine control units (ECUs) or the like typically requires significant time and/or expense.

### SUMMARY OF THE INVENTION

The present invention provides a method for reflashing a plurality of engine control units. The method includes connecting a multi-channel power distributor to a power supply and connecting a plurality of engine control units (ECUs) to the multi-channel power distributor. A respective ECU is connected to a respective channel of the power distributor so that each ECU is powered by a separate channel of the power distributor. Each ECU is also connected to a vehicular communication bus controller, such as a controller area network (CAN) controller or the like. Each ECU is connected to a different CAN channel and the CAN controller is connected to data processing hardware (such as a computer). The method also includes reflashing each ECU simultaneously with the data processing hardware.

These and other objects, advantages, purposes and features of the present invention will become apparent upon review of the following specification in conjunction with the drawings.

### BRIEF DESCRIPTION OF THE DRAWINGS

FIG. 1 is an exemplary image of a power supply, a power distributor, controller area network (CAN) cases, and engineering control units (ECUs) in accordance with the present invention;

FIG. 2 is an exemplary image of the power distributor box and CAN cases in accordance with the present invention; and

FIG. 3 is an exemplary image of a plurality of displays displaying software tools for reflashing ECUs in accordance with the present invention.

### DESCRIPTION OF THE PREFERRED EMBODIMENTS

When an engine control unit (ECU) needs to be reflashed with updated software, there are external hardware tools along with application tools that are necessary for successful completion of the reflashing. For example, a Mazda team and a Chrysler team connect an ECU to a controller area network (CAN) case and a power supply. The ECU is then reflashed through a software tool (e.g., Diagnostics Engineering Tool). After the ECU is connected, the reflashing process takes approximately 40-50 seconds to complete.

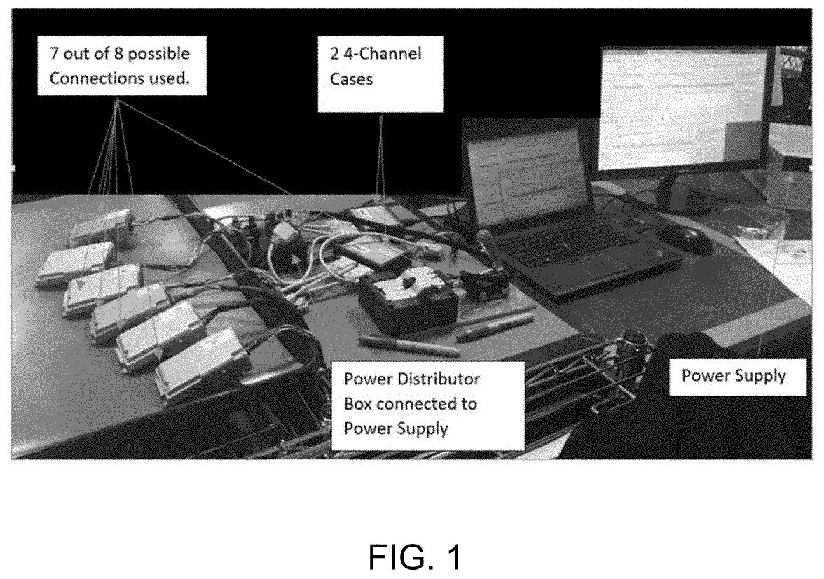

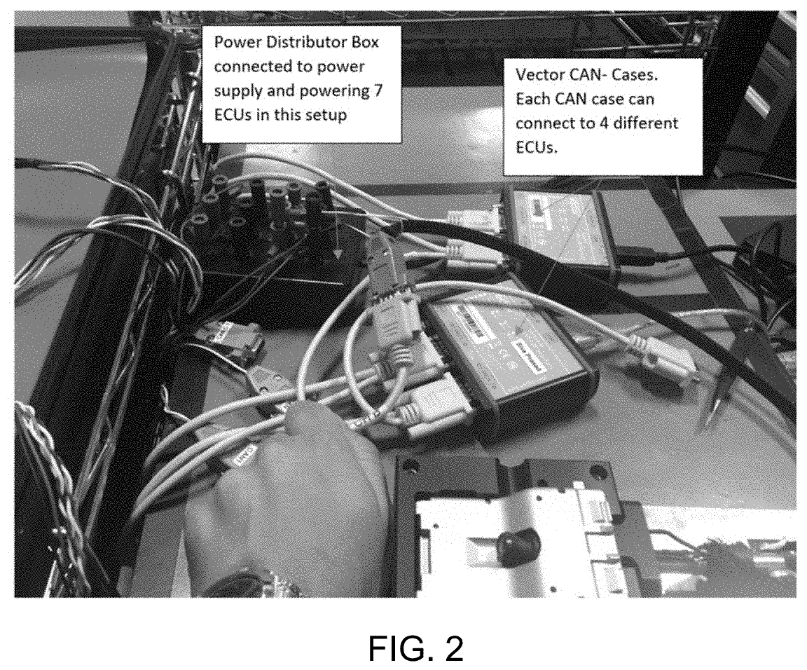

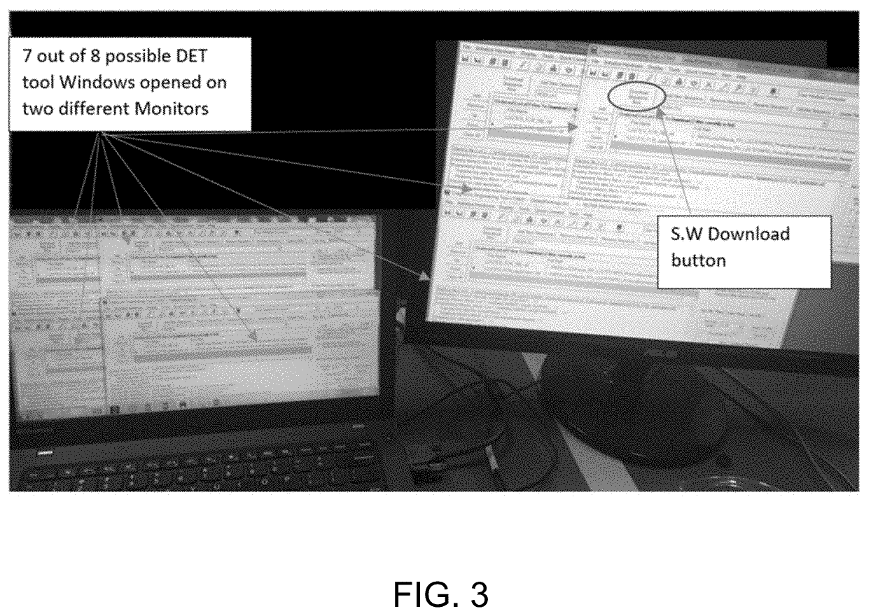

Referring now to the drawings and the illustrative embodiments depicted therein, a plurality of ECUs may be programmed simultaneously through the use of a power distributor box, a power supply, multi-channel CAN cases, and data processing hardware (e.g., a personal computer, laptop, etc.) (FIG. 1). As shown in FIG. 2, a multiple channel power distributor is connected to a power supply and two four-channel (for example) CAN cases are connected to a computer via USB or any other appropriate protocol. Each ECU is connected to a separate channels on the power supply. In the illustrated example, up to eight connections are shown, but more or less may be used. As shown in FIG. 3, one or more displays (e.g., computer monitors) connect to the data processing hardware. For example, the monitors may connect via VGA or HDMI.

Still referring to FIG. 3, the data processing hardware executes dedicated software tools for reflashing the ECUs (e.g., Diagnostics Engineering Tool). In FIG. 3, a software tool instance is provided for each ECU, but a software tool may support multiple ECUs with a single instance. Each instance of the software tool may be provided a unique identifier that links the instance to a respective ECU. In this way, a programming failure can easily be traced to a respective ECU. After the software tools are configured to reflash the ECUs, the power supply is enabled, thereby providing power to the power distributor box and then providing power to each ECU via the power distributer box. After power is applied, the software tools commence execution of ECU reflashing. In this way, all connected ECUs are reflashed simultaneously via identical CAN programming data transmitted to each ECU via the ECU's respective CAN channel. After reflashing finishes, each ECU may be disconnected and new ECUs connected to repeat the process. The reflashed ECUs may be marked and stored in designated trays to, for example, commence additional testing (e.g., final functional testing).

Commonly, an ECU includes a harness attachment to a camera that includes a pin lock mechanism that prevent the disconnection of the harness in vehicles. To ease disconnecting the harness from the cameras for the purpose of reflashing, the lock may be restricted (e.g., taped down) to allow quick release and decrease the possibility of bending pins due to quick handling of the parts.

Thus, the system or process of the present invention can reflash a plurality of ECUs in a timely and efficient manner. The system or process includes connecting a multiple way power distributor to a power supply and connecting, for example, two 4-channel CAN cases to a computer via USB (FIG. 2). One ECU is connected to each of the 4 channels on each power supply (8 possible connections). An extra monitor may be connected to the laptop through VGA or HDMI (FIG. 3). Eight different diagnostic engineering tool (DET) Windows may be opened with each window connected to one CAN channel (FIG. 3). All DET windows are pre-loaded with the software to be downloaded on the ECU. The method includes setting up/stacking up all 8 windows on the two monitors in a way that allows the operator to simply click on one button to begin the Reflash (FIG. 3). The power supply is powered with 12 V nominal. The operator then may click on each of the eight buttons on the eight different windows to have eight different ECU reflashed at the same time. When completed, the completed ECUs are disconnected and eight new ECUs are connected and the operator can again select the buttons on the windows to reflash the next set of ECUs, and so on. While the eight new ECUs are being reflashed, the eight previously completed ECUs can be marked and stored in a designated tray to go back through final functional testing (such as in situations where the reflash is performed in the assembly plant).

Execution of the described method by an inexperienced operator may allow up to 1600 ECUs be reflashed in eight hours. This saves substantial time and/or expenses and may eliminate the need to employ expensive third-party solutions or transport the parts away from their facility.

Changes and modifications in the specifically described embodiments can be carried out without departing from the principles of the invention, which is intended to be limited only by the scope of the appended claims, as interpreted according to the principles of patent law including the doctrine of equivalents.

1. A method for reflashing a plurality of engine control units, the method comprising:
connecting a multi-channel power distributor to a power supply;
connecting a plurality of engine control units (ECUs) to the multi-channel power distributor, wherein each ECU of the plurality of ECUs is connected to a respective channel of the multi-channel power distributor;
connecting each ECU to a vehicular communication bus controller, wherein each ECU is connected to a different channel of the vehicular communication bus controller;
connecting the vehicular communication bus controller to data processing hardware; and
reflashing each ECU simultaneously with the data processing hardware.

2. The method of claim 1, comprising displaying on a display, results from the data processing hardware.

3. The method of claim 2, wherein displaying on the display the results comprises displaying separate results for each ECU.

4. The method of claim 2, wherein displaying on the display the results comprises displaying integrated results for each ECU.

5. The method of claim 1, wherein each ECU is assigned a unique identifier.

6. The method of claim 5, wherein the unique identifier identifies a failed reflashing of a respective ECU.

7. The method of claim 1, wherein the vehicular communication bus controller comprises a controller area network (CAN) controller.

8. The method of claim 7, wherein reflashing each ECU comprises simultaneously transmitting identical CAN data over each CAN channel to each respective ECU.

9. The method of claim 7, wherein the CAN controller comprises two four-channel CAN controllers.

10. The method of claim 7, wherein connecting the CAN controller to the data processing hardware comprises connecting the CAN controller to the data processing hardware via USB.

11. The method of claim 1, wherein the multi-channel power distributor comprises eight channels.

12. The method of claim 1, further comprising restricting a connector retention of each ECU.

13. A method for reflashing a plurality of engine control units, the method comprising:
connecting a multi-channel power distributor to a power supply;
connecting a plurality of engine control units (ECUs) to the multi-channel power distributor, wherein each ECU of the plurality of ECUs is connected to a respective channel of the multi-channel power distributor;
connecting each ECU to a controller area network (CAN) controller, wherein each ECU is connected to a different CAN channel;
connecting the CAN controller to data processing hardware;
reflashing each ECU simultaneously with the data processing hardware, wherein each ECU is assigned a unique identifier, and wherein the unique identifier identifies a failed reflashing of a respective ECU; and
displaying on a display, results from the data processing hardware.

14. The method of claim 13, wherein displaying on the display the results comprises displaying separate results for each ECU.

15. The method of claim 13, wherein displaying on the display the results comprises displaying integrated results for each ECU.

16. The method of claim 13, wherein reflashing each ECU comprises simultaneously transmitting identical CAN data over each CAN channel to each respective ECU.

17. The method of claim 13, wherein the CAN controller comprises two four-channel CAN controllers.

18. The method of claim 13, wherein the multi-channel power distributor comprises eight channels.

19. A method for reflashing a plurality of engine control units, the method comprising:
connecting an eight-channel power distributor to a power supply;
connecting a plurality of engine control units (ECUs) to the eight-channel power distributor, wherein each ECU of the plurality of ECUs is connected to a respective channel of the eight-channel power distributor;
connecting each ECU to one of two four-channel CAN controllers, wherein each ECU is connected to a different CAN channel;
connecting each of the two four-channel CAN controllers to data processing hardware; and
reflashing each ECU simultaneously with the data processing hardware.

20. The method of claim 19, further comprising restricting a connector retention of each ECU.
